(19) United States
(12) Patent Application Publication
(10) Pub. No.: US 2005/0212282 A1
(43) Pub. Date: Sep. 29, 2005

(54) Removable mud flap system

(76) Inventor: Troy Markham, Murray, UT (US)

Correspondence Address: MARCUS G THEODORE, PC, 466 SOUTH 500 EAST, SALT LAKE CITY, UT, 84102, US

(21) Appl. No.: 11/059,260

(22) Filed: Feb. 16, 2005

Related U.S. Application Data
(60) Provisional application No. 60/544,823, filed on Feb. 17, 2004.

(51) Int. Cl. B62D 25/18

(52) U.S. Cl. 280/851

(57) ABSTRACT

An improved mud flap system, which can be added when items are towed behind vehicles and quickly removed and stored, when not required. It also enables the employment of different interchangeable mud flaps to be installed to satisfy the color and design preference of a user.

### RELATED APPLICATIONS

This application is a continuation-in-part of the provisional patent application entitled “Removable Mud Flap System filed Feb. 17, 2004, Ser. No. 60/544,823

### BACKGROUND OF THE INVENTION

1. Field

This invention pertains to mud flaps for vehicles. In particular it pertains to an improved removable mud flap system trucks and vehicles with trailer hitch mounts.

2. State of the Art

A number of mud flap systems for vehicles are known, such as Bucho, U.S. Pat. No. 5,833,254 dated Nov. 20, 1998, which has a mud flap system associated with the ends of the sleeves of a hitch receiver employing a U-bolt or flange retaining block to lock the beam assembly of the mud flap into the trailer receiver hitch transverse bar. Other mud flap systems are: Burnstein, U.S. Patent Publication No. U.S. 2001/0030407A1 dated Oct. 18, 2001; Burnstein, U.S. Pat. No. 6,485,059 B2 dated Nov. 26, 2002; Knoer, U.S. Pat. No. 6,076,842 dated Jun. 20, 2000; Larkin et al., U.S. Pat. No. 6,179,311B1 dated Jan. 30, 2001; Haddox, U.S. Pat. No. 5,121,944 dated Jun. 16, 1992; Kirckof, U.S. Pat. No. 6,375,223B1 dated Apr. 23, 2002; Whitaker, U.S. Pat. No. 4,319,764 dated Mar. 16, 1982; Hammond, Jr., U.S. Pat. No. 6,289,935 B1 dated Sep. 18, 2001; Ahleen, Des. No. 328,447 dated Aug. 7, 1992; Hooper et al., Des. No. 330,692 dated Nov. 3, 1992. These mud flap systems have various advantages and disadvantages. The present invention provides an improved quick locking system that enables the mud flaps to be removed or installed with a minimum of effort.

### SUMMARY OF THE INVENTION

The invention comprises a removable mud flap system. It has a pair of removably mountable mud flaps with hanger arms with attachment ends, which removably secure within the open ends of the horizontal tubing of a trailer hitch of a truck or SUV. These horizontal trailer hitch tubes are square shaped tubes. The mud flaps are attached to a square tubing hanger arm with an end adapted to insert and removably secure within the open ends of the square trailer hitch horizontal tubing via a friction or locking system. The hanger arm is of a length to position the mud flap behind the rear wheel when mounted. The hanger arm is preferably constructed of square tubular steel to which the mud flaps may be removably mounted thereon and changed to suit the preference of a user.

The end of the square tubing hanging arm has slits in the corners to separate the segments of the sides which insert within the square trailer hitch, such that they expand when pushed apart by an internal cam. The locking system shown is an internal locking system that consists of an expansion square cam “camlock” with rounded edges connected to a handle. When the handle is rotated, it rotates a cam to an expanded position where its rounded edges push against the ends of the separated segments of the sides of the square tubing hanger arm expanding the separated side segments to press tight against plastic inserts placed between the trailer hitch square tubing and the square hanger arm segments to wedge it and the hanger arm segments within the horizontal tubing of the trailer hitch. The nylon insert is included to compensate for trailer hitch horizontal tubing size inconsistencies and roll welds, and assists in holding the mud flaps in position when the cam lock is activated. Preferably, it is in two pieces with longitudinal exterior grooves to accommodate any roll welds when inserted within the ends of the trailer hitch horizontal tubing. The separate pieces of the insert allow it to expand and secure against the interior of the trailer hitch horizontal tubing when the cam lock is activated.

The cam is turned in one direction expanding the ends of the hanger arm square tubing tight against the nylon inserts to secure it within the trailer hitch horizontal tubing, and then rotated back to release the same.

A preferred embodiment of the two-piece insert has tapered ends proximate the cam so that its sidewalls may more readily separate and expand against the interior of the trailer hitch horizontal tubing.

This invention is used primarily to provide mud flap road protection to boats and other items when towed behind a truck or SUV. In many states, mud flaps are required when towing. As they add wind resistance, it is desirable to remove them to improve mileage. The present invention therefore enables one to remove the mud flap system when the towed items are removed and stored. It also enables the employment of different interchangeable mud flaps to be installed to satisfy the color and design preference of a user.

### DESCRIPTION OF THE DRAWINGS

FIG. 1 is a perspective view of a preferred embodiment.

FIG. 2 is a perspective view of the preferred embodiment shown in FIG. 1 in a folded position.

FIG. 3 is a side view of the preferred embodiment shown in FIG. 1.

FIG. 4 is a perspective view of the insert.

FIGS. 5a and 5b show the cam in a locked and unlocked positions.

FIG. 6 shows a preferred embodiment of a two piece insert.

### DESCRIPTION OF THE ILLUSTRATED EMBODIMENTS.

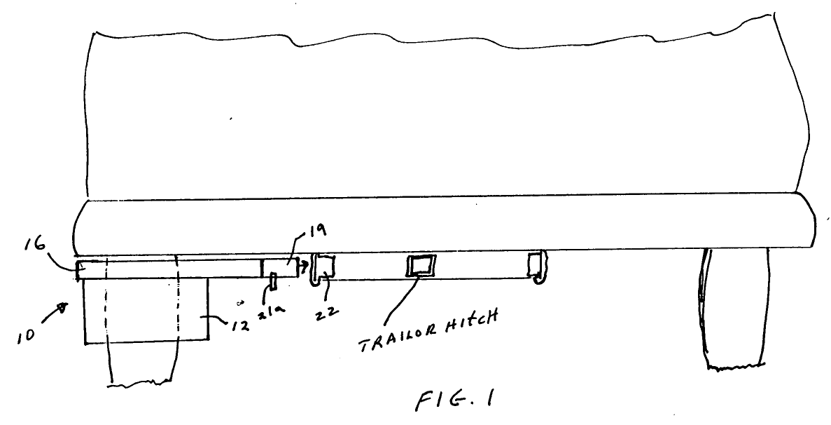

The invention comprises a mud flap system 10 shown in the attached drawing. FIG. 1 shows a pair of removably mountable mud flaps 12, which removably secure within the open ends of the horizontal tubing of a trailer hitch of a truck or SUV. The mud flaps 14 are attached to a square tubing hanger arm 16 with an end 18 adapted to insert and removably secure within the open ends of the trailer hitch horizontal tubing via a friction or locking system 20. The locking system 21 shown is an internal locking system that consists of an expansion cam “camlock” connected to a handle 21a. When the handle is rotated, it turns a cam 21b to an expanded position expanding the end of the square tubing to press tight against the plastic inserts 22 to wedge within the horizontal tubing of the trailer hitch. The nylon insert 22 is included to compensate for trailer hitch horizontal tubing size inconsistencies and roll welds, and assists in holding the mud flaps 12 in position when the cam lock is activated.

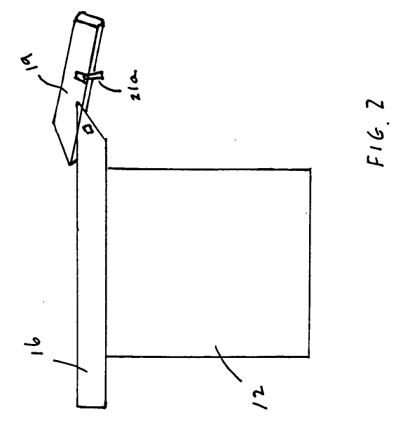

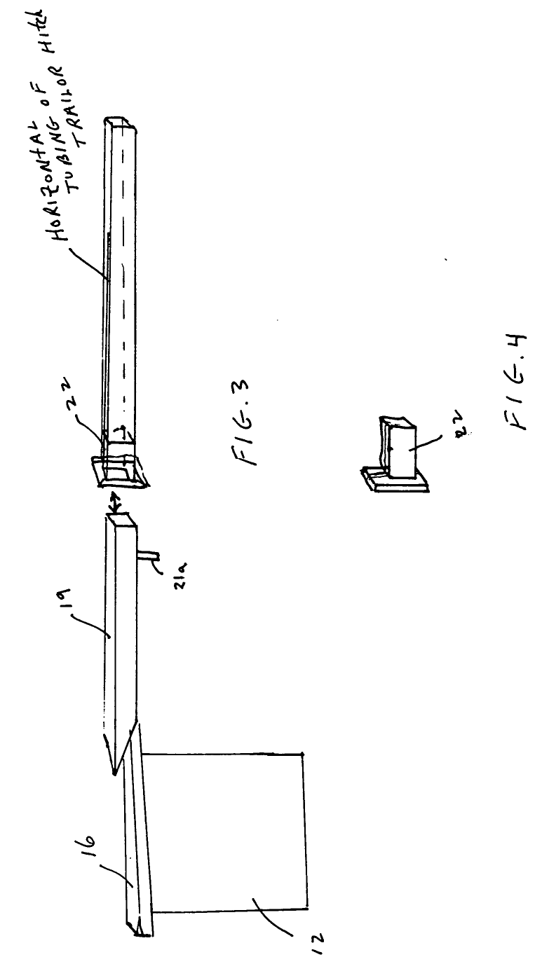

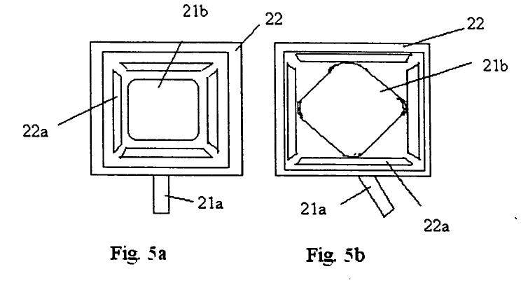

FIG. 2 shows the positioning bar 19 in more detail, and the handle 21a of the locking system 21. FIG. 3 shows the positioning of the nylon insert 22 of FIG. 4 in more detail. FIGS. 5a and 5b illustrate how the cam 21b is turned in one direction expanding the ends 22a of the square tubing tight against the nylon inserts 22 to secure it within the trailer hitch horizontal tubing, and then rotated back to release the same.

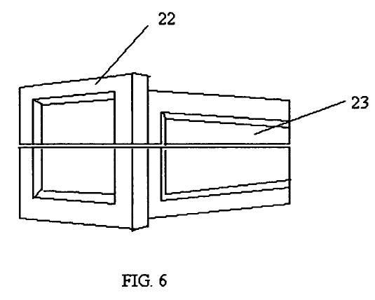

FIG. 6 shows a preferred embodiment of a two-piece insert 22. It has longitudinal grooves 23 along its sides, which are tapered proximate the position of the cam lock to more readily expand when forced by the cam lock.

Although this specification has referred to the illustrated embodiments, it is not intended to restrict the scope of the claims, The claims themselves recite those features deemed essential to the invention.

1. A removable mud flap system to removably secure within the open ends of the horizontal square tubing of a trailer hitch of a truck or SUV comprising:
a. a pair of removably mountable mud flaps with hanger arms holding the mud flaps at one end and at the other end attachment ends, which removably secure within the open ends of the horizontal square tubing of the trailer hitch by expansion fitting, the hanger arms of a length to position the mud flaps behind the rear wheels when mounted, and
b. an internal cam locking system mounted within the attachment ends to expand the attachment ends against the horizontal square tubing when turned in one mode, and retract the attachment ends to release the attachment ends against the square tubing in a second mode.

2. A removable mud flap system according to claim 1, wherein the ends of the square tubing hanging arm have side corners with slits in them to separate the segments of the sides and expand when pushed apart by the internal cam.

3. A removable mud flap system according to claim 1, wherein the locking system consists of an expansion square cam “camlock” with rounded edges connected to a handle.

4. A removable mud flap system according to claim 3, wherein when the handle is rotated, it rotates the cam into an expanded position where its rounded edges push against the ends of the separated segments of the sides of the square tubing hanger arm.

5. A removable mud flap system according to claim 4, including an expandable insert placed between the trailer hitch square tubing and the square hanger arm segments to wedge them against the hanger arm segments within the horizontal tubing of the trailer hitch, when the cam is activated.

6. A removable mud flap system according to claim 5, wherein the expandable inserts are structured to compensate for trailer hitch horizontal tubing size inconsistencies and roll welds.

7. A removable mud flap system according to claim 6, wherein the expandable insert is in two pieces with longitudinal exterior grooves to accommodate any roll welds when inserted within the ends of the trailer hitch horizontal tubing

8. A removable mud flap system according to claim 7, wherein the two-piece insert is made of nylon and has tapered ends proximate the cam so that its sidewalls may more readily separate and expand against the interior of the trailer hitch horizontal tubing.

9. A removable mud flap system according to claim 1, wherein the mud flaps are removably mounted to the hanger arms and can be interchanged with other mud flap patterns and styles to meet the preference of a user.
